(19) United States
(12) Patent Application Publication
(10) Pub. No.: US 2021/0340987 A1
(43) Pub. Date: Nov. 4, 2021

(54) SIDE CHANNEL COMPRESSOR FOR COMPRESSING A GAS

(71) Applicant: MAHLE International GmbH, Stuttgart (DE)

(72) Inventors: Steffen Huebner, Leonberg (DE); Daniel Schatz, Stuttgart (DE); Johannes Weinmann, Stuttgart (DE)

(21) Appl. No.: 17/246,560

(22) Filed: Apr. 30, 2021

(30) Foreign Application Priority Data
Apr. 30, 2020 (DE) 10 2020 205 533.5

(51) Int. Cl. F04D 27/00; F04D 29/40

(52) U.S. Cl. CPC F04D 27/00; F04D 27/001; F04D 29/406

(57) ABSTRACT

A side channel compressor for compressing a gas includes a housing, in which a side channel is arranged, which can be supplied with gas via a feed channel formed within the housing for feeding gas to the side channel and a discharge channel formed within the housing for discharging gas out of the side channel, wherein in the housing an impeller drive is arranged, wherein the side channel compressor includes a drive control for regulating and/or controlling the impeller drive. The impeller drive includes an impeller which on the output side engages in the side channel of the housing in order to drivingly interact with a gas. The side channel is designed for redirecting the gas flowing through the side channel by at least 270°. The drive control includes an integrated pressure sensor for measuring a gas pressure of the gas flowing within the side channel.

### CROSS REFERENCE TO RELATED APPLICATIONS

This application claims priority to German patent application DE 10 2020 205 533.5, filed Apr. 30, 2020, the entire content of which is incorporated herein by reference.

### TECHNICAL FIELD

The disclosure relates to a side channel compressor for compressing a gas.

### BACKGROUND

In DE 10 2017 221 318 A1 an internal combustion engine with a crankcase ventilation device is described, which comprises an electrically driven delivery device, which with a blow-by gas line is fluidically connected to a crankcase. The electrically driven delivery device can be designed as side channel compressor, which comprises a rotating blade impeller, which between an inlet and an outlet of the side channel compressor generates a pressure difference, wherein at the inlet there is a lower pressure than on the outlet. The blade impeller drive can be controlled in a regulated manner with a drive control, wherein a pressure regulation is employed, which with a pressure sensor measures a gas pressure within the crankcase ventilation device. The pressure sensor can be arranged in the crankcase, at the inlet of the delivery device or in the blow-by gas line upstream of the delivery device. Here, the pressure sensor is communicatingly connected to the drive control with a wiring harness. Disadvantageous in this is that the side channel compressor, through the cable harness routing is relatively complex and large from a construction point of view. In addition, the susceptibility to EMC interferences and/or vibrations rises with increasing cable harness length.

### SUMMARY

It is therefore an object of the disclosure to improve or to provide at least another embodiment of a side channel compressor. Practically, it is to be attempted to embody a side channel compressor to be relatively compact.

In the present disclosure, this object is achieved by a side channel compressor for compressing gas as described herein.

A basic idea of the disclosure lies in integrating the pressure sensor directly in the drive control.

According to the disclosure, it is provided for this purpose to provide a side channel compressor for compressing a gas, e.g., air or blow-by gas of an internal combustion engine, which comprises a housing that can be practically embodied in multiple parts. In the interior, the housing forms an annular side channel that can be flowed through, which is fluidically connected to a feed channel formed within the housing and a discharge channel likewise formed within the housing. The feed channel serves for feeding gas to the side channel, the discharge channel for discharging gas out of the side channel. Furthermore, the side channel compressor has an impeller drive arranged in the housing, which on the output side engages in the side channel with an impeller having multiple impeller blades, in order to drive the gas located therein. By way of this, the gas in the side channel can be driven or compressed, in particular so that it has a higher gas pressure in the discharge channel than in the feed channel. In order to control the impeller drive, the side channel compressor, furthermore, comprises a drive control for regulating and/or controlling the impeller drive that is touchingly arranged on the housing. It is substantial for the disclosure that this drive control comprises an integrated pressure sensor for measuring a gas pressure of the gas flowing within the side channel. Here, the term “integrated” practically means that the drive control and the pressure sensor are connected to one another in a directly touching manner. Because of this, a separate cable harness and the passing of the same through the housing of the side channel compressor can be dispensed with. Because of this, the side channel compressor is relatively compact comparatively speaking. Together with the cable harness, the susceptibility to EMC interferences and/or vibrations of the same are also omitted, as a result of which the side channel compressor gains operational reliability. Furthermore, connectors and further interfaces are no longer required so that the side channel compressor is also less complex and lighter in weight.

With the pressure sensor, the drive control can form an assembly unit which is, in particular detachably, attached to the housing. Prior to its final assembly on the side channel compressor, the assembly unit can be pre-assembled elsewhere, as a result of which the final assembly of the side channel compressor is simplified and more flexible.

Practically, the side channel compressor can comprise at least one riser channel penetrating the housing. Practically, the respective riser channel is completely arranged in the interior of the housing, i.e., quasi an internal riser channel and on the one hand connects the pressure sensor to the side channel on the other hand. Obviously, the riser channel can instead or additionally fluidically connect the pressure sensor to the feed channel or to the discharge channel. Altogether, the pressure sensor can thereby fluidically communicate with the relevant channel or be impinged on by the gas flowing through the same. The riser channel creates a structural distance between pressure sensor and the corresponding channel. Because of the distance gained, the pressure sensor can be arranged relatively freely in the housing, in particular, one has the design freedom, to relatively easily integrate the pressure sensor in the drive control. In practice, a riser channel sealing means can be additionally arranged between the riser channel and the pressure sensor, for example an O-ring or a sealing cord, in order to avoid leakages.

Further practically, the riser channel, forming a channel mouth in the side channel, can open out in the discharge channel or in the feed channel. Because of this, gas can flow out of the respective channel into the riser channel and then to the pressure sensor. This has the advantage that the gas pressure in the respective channel can be determined without further flow components being required.

In order to provide a gas pressure of the gas flowing within the side channel, the discharge channel or the feed channel on the pressure sensor, it is provided, furthermore, that the riser channel, in particular with respect to the channel mouth arranged on the one end, defines a pressure sensor mouth at the other end. The pressure sensor can be fluidically communicatingly and practically touchingly arranged at this pressure sensor mouth. Because of this, gas can flow out of the riser channel to the pressure sensor. Because of this, it is possible to quasi measure with the pressure sensor through the riser channel, i.e., be fluidically connected to the side channel, the discharge channel or the feed channel.

Practically, a pressure riser line which, with respect to the pressure sensor and the housing, is configured separately, integrally and hollow-cylindrically, can be arranged between the pressure sensor mouth of the riser channel and the pressure sensor. This can fluidically connect the pressure sensor with the riser channel. By way of this, the pressure sensor can also be arranged spaced apart from the pressure sensor mouth. For example, the pressure sensor, because of this, can be directly soldered onto a control circuit board of the drive control, and a structurally-induced distance between pressure sensor and pressure sensor mouth can then be bridged with the pressure riser line.

In order to be able to mount the pressure riser line relatively easily on the side channel compressor, the pressure rise line can be fixed to the pressure sensor in an integrally bonded manner and, on the riser line side, be touchingly plugged in to the pressure sensor mouth. In this way, the pressure riser line can be realized relatively cost-effectively.

Further practically, the drive control can comprise a circuit board holder, a control circuit board touchingly held thereon and a housing cover. The control circuit board can be for example realized as PCB board (printed circuit board) and practically carry various electronic components. During the operation of the side channel compressor, the circuit board holder can be directly attached to the or at least in the region of the installation chamber on the housing of the side channel compressor. Here, the control circuit board is practically held on a large surface of the circuit board holder facing away from the housing of the side channel compressor. Furthermore, the two components thus arranged on the housing can be completely covered by the housing cover all-round. Here it is practical to provide a housing sealing means between housing cover and circuit board holder, for example an O-ring or a sealing cord, which sealingly lies against the circuit board holder on the one hand and against the housing cover on the other hand in order to protect the control circuit board for example from moisture. In summary, this has the advantageous effect that the control circuit board is protected from interference influences all-round and firmly held on the housing of the side channel compressor.

Practically, the pressure sensor can be directly soldered to the control circuit board so that additional cabling can be omitted. This has the advantageous effect that the pressure sensor is arranged on the control circuit board in an integrally bonded, firm and captive manner. Additional cabling can also be omitted. Practically, pressure sensor lugs are arranged on the pressure sensor which favor the soldering-on. The control circuit board with pressure sensor therefore has an altogether relatively small installation space requirement. The own weight is also relatively low.

Further practically, the pressure sensor can be arranged, sandwich-like, between the control circuit board on the one hand and the circuit board holder on the other hand, wherein the pressure sensor touchingly supports itself on the circuit board holder. Thus, the pressure sensor is firmly arranged within the drive control and immovable with respect to the control circuit board and the circuit board holder. By way of this it is ensured for example that the pressure sensor during the operation of the side channel compressor can reliably measure the gas pressure within the side channel.

Furthermore, the housing cover can be fixed or is fixable to the housing with fastening screws. Here, the fastening screws each engage through a centering tab protrudingly arranged on the circuit board holder, in order to align the housing cover, the circuit board holder, the control circuit board and the pressure sensor, i.e., practically the assembly unit, with respect to the housing and the riser channel. This has the advantageous effect that the mentioned components can be centered in order to ensure a perfect operation of the pressure sensor.

Furthermore, an ambient reference pressure can be provided on the pressure sensor by way of a diaphragm arranged in the drive control. By way of this, a reference pressure (atmospheric pressure) originating from the surroundings of the side channel compressor can be provided on the pressure sensor. Exemplarily, the pressure sensor is therefore embodied as relative pressure sensor.

It is practical, furthermore, when the pressure sensor is arranged in the housing of the side channel compressor in a suspended manner. This produces the advantage that liquid precipitating on the pressure sensor can drain downwards by the force of gravity. During the operation of the side channel compressor, the pressure sensor is therefore arranged comparatively dry and distant from liquid accumulations. Because of this, the pressure sensor can operate relatively free of interferences and have a long service life.

Further practically, the side channel can be designed for diverting the gas flowing through the side channel by at least 200°, preferentially 220°, further preferentially 240° or further preferentially 270°. Here, the feed channel can branch into two separate channel arms each extending along a channel arm center axis, which for their part are spaced apart from one another in the direction of a transverse axis connecting the two channel arm center axes. In order to realize the redirection of the gas in particular by at least 270°, the discharge channel can be passed through between the two channel arms. Because of this, the side channel compressor is configured altogether relatively compact and flow-favorably.

It is conceivable, furthermore, that the riser channel, forming a channel mouth each, opens out on one or on both channel arms of the feed channel. Because of this, the gas pressure of the gas in the channel arms can be tapped off.

In summary it remains to be noted: the present disclosure preferentially relates to a side channel compressor for compressing a gas, having a housing in which a side channel is arranged, which via a feed channel formed within the housing for feeding gas to the side channel and a discharge channel formed within the housing for discharging gas out of the side channel can be supplied with gas, wherein in the housing an impeller drive is arranged, wherein the side channel compressor comprises a drive control for regulating and/or controlling the impeller drive. The impeller drive comprises an impeller which on the output side engages in the side channel of the housing in order to drivingly interact with a gas. The side channel is designed for redirecting the gas flowing through the side channel by at least 270°. According to the disclosure, the drive control comprises an integrated pressure sensor for measuring a gas pressure of the gas flowing within the side channel.

Further important features and advantages of the disclosure are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present disclosure.

Preferred exemplary embodiments of the disclosure are shown in the drawings and are explained in more detail in the following description, wherein same reference numbers relate to same or similar or functionally same components.

### BRIEF DESCRIPTION OF THE DRAWINGS

The disclosure will now be described with reference to the drawings wherein:

FIG. 1 shows a perspective view of a preferred exemplary embodiment of a side channel compressor according to the disclosure and

FIG. 2 shows a sectional view of the side channel compressor from FIG. 1 according to a section plane drawn in there in viewing direction of an arrow II.

### DESCRIPTION OF EXEMPLARY EMBODIMENTS

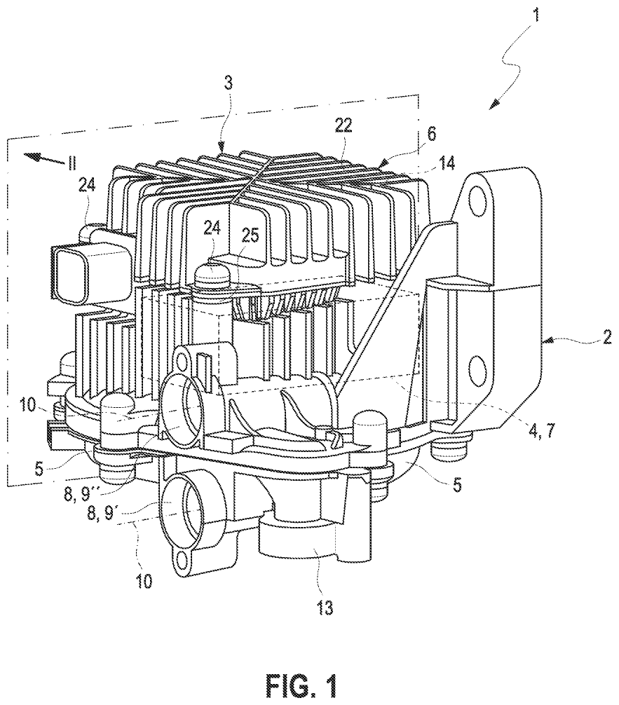

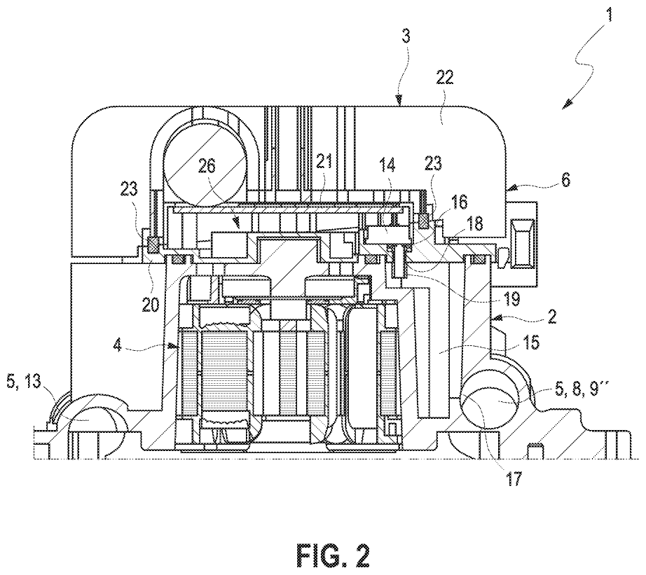

The two FIGS. 1 and 2 show a preferred exemplary embodiment of a side channel compressor altogether marked with 1 which serves for compressing gas, for example air or blow-by gas of an internal combustion engine. In FIG. 1, a perspective view of the side channel compressor 1 is noticeable, which comprises a housing marked with the reference number 2. The housing 2 for its part has an internal installation chamber in which exemplarily at least one impeller drive 4 for driving gas through a side channel 5 formed by the housing 2 is arranged.

The side channel 5 is exemplarily designed for redirecting the flowing gas by 270° and fluidically connected to a feed channel 8 formed with the housing 2 and a discharge channel 13 likewise formed within the housing 2. Here, the feed channel 8 serves for feeding gas to the side channel 5 and the discharge channel 13 for discharging gas out of the side channel 5. According to FIG. 1, the feed channel 8 branches into two separate channel arms 9′, 9″ each extending along a channel arm center axis 10. The channel arms 9′, 9″ open out on the housing 2 in order to each form a gas inlet for gas there. The channel arms 9′, 9″ are spaced apart from one another in the direction of a transverse axis connecting the two channel arm center axes 10, so that the discharge channel 13 can be guided within the housing 2 so that it passes through between the two channel arm 9′, 9″. The discharge channel 13, opens out on the housing 2 forming a gas outlet for gas. According to this type, the side channel compressor 1 can be embodied in a relatively compact manner.

In order to drive gas through the side channel 5, the mentioned impeller drive 4 has an impeller 7 on the output side. The impeller 7 for its part has at least multiple impeller blades which are not illustrated in FIGS. 1 and 2, which engage in the side channel 5 of the housing 2 in order to drivingly interact with the gas.

In order to control the impeller drive 4 in a regulated manner, the side channel compressor 1, furthermore, comprises a drive control 6 touchingly attached to the housing 2, which is exemplarily designed for regulating the impeller drive 4.

It is substantial that the drive control 6 comprises an integrated pressure sensor 14 for measuring a gas pressure of the gas flowing within the side channel 5 of the feed channel 8 and/or of the discharge channel 13, see FIGS. 1 and 2. By way of this, the drive control 6 and the pressure sensor 14 practically form an integral assembly unit 3 which in particular as part of the manufacture of the side channel compressor 1, can be handled relatively easily. In order to measure the gas pressure of the gas in the side channel 5, it is necessary that the pressure sensor 14 is impinged on by gas or gas pressure. For this purpose, gas from the side channel 5 has to reach the pressure sensor 14. For this purpose, the side channel compressor 1 has an internal riser channel 15 penetrating the housing 2 in sections, which, forming a channel mouth 17, exemplarily opens out at one end in the channel arm 9″ of the feed channel 8 and on the other hand defines a pressure sensor mouth 18, on which the pressure sensor 14 is touchingly arranged. In this way, the pressure sensor 14 can communicate with the gas through the riser channel or be impinged with gas pressure, i.e., exemplarily fluidically communicate with the gas in the channel arm 9″ of the feed channel 8. In summary, the riser channel 15 makes it possible to arrange the pressure sensor 14 spaced apart from the side channel 5, from the feed channel 8 and from the discharge channel 13, which favors the integratability of the pressure sensor 14. In order to avoid leakages between the riser channel 15 and the pressure sensor 14 in practice, a riser channel sealing means 16 can be arranged between the riser channel 15 and the pressure sensor 14, see FIG. 2.

According to FIG. 2, a sectional view of the side channel compressor 1 from FIG. 1 is illustrated according to a section plane in the viewing direction of an arrow II drawn in there. It is noticeable, among other things, that the drive control 6 of the side channel compressor 1 comprises a circuit board holder 20, a control circuit board 21 held thereon and a housing cover 22. The pressure sensor 14 is directly soldered to the control circuit board 21, for example by way of pressure sensor housing lugs, wherein the control circuit board 21 for its part is fixed to the circuit board holder 20. The circuit board holder 20 for its part is touchingly attached to the housing 2, namely exemplarily from outside above, on a housing side of the housing 2 opposite the side channel 5. Interposing a housing sealing means 23, the housing cover 22 is sealingly placed against the circuit board holder 20. Thus, the control circuit board 21 is completely covered by the housing cover 22 so that it is held all round protected from interference influences and fixed to the housing 2 of the side channel compressor 1. In order for the housing cover 22 and the circuit board holder 20 to be firmly and captively seated on the housing 2 during the operation of the side channel compressor 1, the housing cover 22 is exemplarily fixed to the housing 2 with four fastening screws 24, see FIG. 1. Here, the circuit board holder 20 is tightly clamped between the housing cover 22 and the housing 2. The four fastening screws 24 each engage through a centering tab 25 arranged on the circuit board holder 20, in order to center the circuit board holder 20. By way of this, a perfect operation of the side channel compressor 1 can be ensured.

In FIG. 2 it is also noticeable that in the pressure sensor mouth 18 of the riser channel 15 and the pressure sensor 14 a pressure riser line 19 penetrating the riser channel sealing means 16 which, with respect to the pressure sensor 14, the housing 2 and the riser channel sealing means 16, is configured separately, integrally and hollow-cylindrically, is arranged, which fluidically connects the pressure sensor 14 with the riser channel 15. Exemplarily, the pressure riser line 19 is fixed to the pressure sensor 14 in an integrally bonded manner and touchingly plugged in on the pressure sensor mouth 18, so that it projects some distance into the riser channel 15. By way of this, the pressure rise line 19 bridges a distance between the pressure sensor 14 and the riser channel 15 that is conditional on the design.

In FIG. 2, the pressure sensor 14 is exemplarily embodied as relative pressure sensor, for the purpose of which the same is impinged on with an ambient reference pressure. The ambient reference pressure is tapped off from the surroundings (atmospheric pressure) of the side channel compressor 1 and provided on the pressure sensor 14 with a diaphragm 26 arranged in the drive control 6. Furthermore, the pressure sensor 14 according to FIG. 2 is arranged suspended in the housing 2 so that liquid precipitating on the pressure sensor 14 can drain downwards by the force of gravity.

It is understood that the foregoing description is that of the exemplary embodiments of the disclosure and that various changes and modifications may be made thereto without departing from the spirit and scope of the disclosure as defined in the appended claims.

What is claimed is:

1. A side channel compressor for compressing gas, the side channel compressor comprising:
a housing, in which an annular side channel is formed, which is fluidically connected to a feed channel formed within the housing for feeding gas to the side channel and to a discharge channel formed within the housing for discharging gas out of the side channel;
an impeller drive arranged in the housing, which on the output side engages with an impeller in the side channel in order to drive gas located therein;
a drive control arranged on the housing for regulating and/or controlling the impeller drive, and
wherein the drive control comprises an integrated pressure sensor for measuring a gas pressure of the gas flowing within the side channel.

2. The side channel compressor according to claim 1, wherein the drive control forms an assembly unit with the pressure sensor which is attached to the housing.

3. The side channel compressor according to claim 1, wherein the side channel compressor comprises a riser channel which penetrates the housing at least in sections, which fluidically connects the pressure sensor with the side channel.

4. The side channel compressor according to claim 3, wherein the riser channel, forming a channel mouth, opens in the feed channel or in the discharge channel or in the side channel.

5. The side channel compressor according to claim 3, wherein the riser channel defines a pressure sensor mouth, on which the pressure sensor is fluidically communicate arranged in order to fluidically connect the pressure sensor with the discharge channel or the feed channel or the side channel.

6. The side channel compressor according to claim 5, wherein between the pressure sensor mouth of the riser channel and the pressure sensor a pressure riser line which with respect to the pressure sensor and the housing is separate and integral, in order to fluidically connect the pressure sensor with the riser channel.

7. The side channel compressor according to claim 6, wherein the pressure rise line is fixed to the pressure sensor in an integrally bonded manner and touchingly plugged into the pressure sensor mouth.

8. The side channel compressor according to claim 1, wherein the drive control comprises a circuit board holder, a control circuit board held thereon and a housing cover, wherein the circuit board holder is arranged on the housing, wherein the housing cover, subject to interposing a housing sealing means, sealingly lies against the circuit board holder and completely covers the control circuit board all round.

9. The side channel compressor according to claim 8, wherein the pressure sensor is directly soldered to the control circuit board.

10. The side channel compressor according to claim 1, wherein the pressure sensor is arranged, sandwich-like, on the one hand between the control circuit board and the circuit board holder on the other hand, and wherein the pressure sensor touchingly supports itself on the circuit board holder.

11. The side channel compressor according to claim 8, wherein the housing cover is fixed to the housing with fastening screws, wherein the fastening screws each engage through a centering tab protrudingly arranged on the circuit board holder, in order to align the circuit board holder, the control circuit board and the pressure sensor with respect to the housing cover, the housing and the riser channel.

12. The side channel compressor according to claim 1, wherein on the pressure sensor an ambient reference pressure is provided via a diaphragm arranged in the drive control.

13. The side channel compressor according to claim 1, wherein the pressure sensor is arranged suspended in the housing of the side channel compressor, such that liquid precipitating on the pressure sensor can drain by the force of gravity.

14. The side channel compressor according to claim 1, wherein:
the side channel is designed for redirecting the gas flowing through the side channel by at least 270°,
the feed channel branches into two separate channel arms each extending along a channel arm center axis,
the discharge channel is passed through between the two channel arms, and
the riser channel, forming a channel mouth, opens out on one or on both channel arms of the feed channel.
